(19) United States
(12) Patent Application Publication
(10) Pub. No.: US 2016/0224080 A1
(43) Pub. Date: Aug. 4, 2016

(54) CALIBRATION MARGIN OPTIMIZATION IN A MULTI-PROCESSOR SYSTEM ON A CHIP

(71) Applicant: QUALCOMM INCORPORATED, San Diego, CA (US)

(72) Inventor: RICHARD ALAN STEWART, San Diego, CA (US)

(21) Appl. No.: 14/697,590

(22) Filed: Apr. 27, 2015

Related U.S. Application Data
(60) Provisional application No. 62/111,081, filed on Feb. 2, 2015.

(51) Int. Cl. G06F 1/20; G05B 13/02

(52) U.S. Cl. CPC G06F 1/206; G05B 13/021

(57) ABSTRACT

Various embodiments of methods and systems for calibration margin optimization of a target component in a portable computing device are disclosed. Because calibration of certain components is most optimally implemented when the component is at a certain operating temperature, or a series of certain operating temperatures, embodiments of the solution leverage thermal energy generation capabilities of nearby components to manage the operating temperature of a target component to be calibrated.

### CROSS-REFERENCE TO RELATED APPLICATIONS

Priority under 35 U.S.C. §119(e) is claimed to U.S. provisional application entitled “CALIBRATION MARGIN OPTIMIZATION IN A MULTI-PROCESSOR SYSTEM ON A CHIP,” filed on Feb. 2, 2015 and assigned application Ser. No. 62/111,081, the entire contents of which are hereby incorporated by reference.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

Various high speed circuits in a PCD require a calibration of timing (and/or other characteristics) in order to ensure that the PCD provides optimal functionality across a wide range of voltage and/or temperature conditions. To keep circuit manufacturing costs low without overly limiting the operating temperature range through which a PCD may efficiently function, designers often employ an initial, one time boot calibration performed at the center of the target operating temperature range. The center of the target operating temperature range is generally designated as “room temperature” and, therefore, it is desirable for calibrations to take place when the operating temperature is as close to room temperature as possible.

Ensuring that the operating temperature is at, or substantially near, room temperature is difficult to do when the calibration is being performed under conditions controlled by a party other than the PCD designers (e.g., an OEM that keeps its manufacturing floor at a temperature well below the room temperature designated by the PCD designers). As a further example, ensuring that the operating temperature is at, or substantially near, room temperature is all but out of the question when the calibration is an over the air (“OTA”) or over the wire (“OTW”) upgrade of a PCD that is in an end user's possession. Moreover, for calibration processes that actually require multiple data points be taken at different operating temperatures (as opposed to multiple data points at a single target room temperature), it is next to impossible to effectively conduct the calibration when the PCD is controlled by a third party.

Accordingly, what is needed in the art is a method and system for generating thermal energy in a PCD such that operating temperatures are raised to optimal points when circuits and/or components in the PCD are undergoing a temperature dependent calibration.

### SUMMARY OF THE DISCLOSURE

Various embodiments of methods and systems for calibration margin optimization of a target component in a portable computing device are disclosed. Because calibration of certain components is most optimally implemented when the component is at a certain operating temperature, or a series of certain operating temperatures, embodiments of the solution leverage thermal energy generation capabilities of nearby components to manage the operating temperature of a target component to be calibrated.

An exemplary calibration margin optimization method first determines that a target component requires calibration. Once the target operating component is recognized, a current operating temperature of the target component may be determined to be cooler than an optimal operating temperature for the calibration. In such case, the exemplary method may increase thermal energy generation by one or more thermally aggressive components near the target component such that the increased thermal energy generation works to adjust the current operating temperature of the target component. Once it is determined that the adjusted current operating temperature of the target component is within an acceptable deviation from the optimal operating temperature for the calibration to be successfully performed, the calibration the target component is performed at the adjusted current operating temperature. Certain embodiments may increase the thermal energy generation by one or more thermally aggressive components by modifying a power supply voltage, modifying a clock generator frequency, and/or modifying a workload allocation.

Notably, for calibration algorithms that require the operating temperature of the target component to be incremented to different operating temperature points, certain embodiments of the solution may subsequently increase thermal energy generation by one or more thermally aggressive components near the target component so that the operating temperature of the target component is also increased. As the method determines that a next operating temperature is achieved to within an acceptable deviation of a next operating temperature point for the calibration, the calibration is performed.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a graph illustrating a pair of calibration curves of an exemplary component operating under different thermal conditions;

FIG. 1B is a graph illustrating an exemplary calibration curve for an exemplary component that requires multiple calibration points at varying operating temperatures;

FIG. 2A is a functional block diagram illustrating aspects of an asynchronous architecture in an on-chip system that includes multiple processing components that may be used by a calibration margin optimization (“CMO”) solution to manage the operating temperature of a nearby component during a calibration process;

FIG. 2B is a functional block diagram illustrating aspects of a synchronous architecture in an on-chip system that includes multiple processing components that may be used by a calibration margin optimization (“CMO”) solution to manage the operating temperature of a nearby component during a calibration process;

FIG. 3 is a functional block diagram illustrating an embodiment of an on-chip system for calibration margin optimization (“CMO”) in a portable computing device (“PCD”);

FIG. 4 is a functional block diagram of an exemplary, non-limiting aspect of a PCD in the form of a wireless telephone for implementing methods and systems for calibration margin optimization (“CMO”) of component(s) within the PCD that are undergoing a calibration process;

FIG. 5A is a functional block diagram illustrating an exemplary spatial arrangement of hardware for the chip illustrated in FIG. 4;

FIG. 5B is a schematic diagram illustrating an exemplary software architecture of the PCD of FIG. 4 and FIG. 5A for supporting application of calibration margin optimization (“CMO”) algorithms; and

FIGS. 6A-6B depict a logical flowchart illustrating an embodiment of a method for calibration margin optimization (“CMO”) of a component in a system on a chip (“SoC”).

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “module,” “system,” “thermal energy generating component,” “processing component,” “thermal aggressor,” “processing engine” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “modem,” and “chip” are non-limiting examples of processing components that may reside in a PCD and are used interchangeably except when otherwise indicated. Moreover, as distinguished in this description, a CPU, DSP, modem or a chip may be comprised of one or more distinct processing components generally referred to herein as “core(s)” and “sub-core(s).”

In this description, “heterogeneous components” includes components different in their intended design as well as components with homogeneous design (same by design) but having different electrical characteristics due to production variation, temperature during operation, and the component location on the silicon die. One of ordinary skill in the art will understand that even in the case that processing components are homogeneous in design, the electrical characteristics of each processing component on an SOC will vary (i.e., be different from each other) due to one or more of silicon leakage production variation, switching speed production variation, dynamic temperature changes during operation in each component, and the component location on the silicon die. As such, one of ordinary skill in the art will recognize that components on a SOC may not be perfectly homogeneous and identical from power and performance perspectives.

In this description, it will be understood that the terms “thermal” and “thermal energy” may be used in association with a device or component capable of generating or dissipating energy that can be measured in units of “temperature.” Consequently, it will further be understood that the term “temperature,” with reference to some standard value, envisions any measurement that may be indicative of the relative warmth, or absence of heat, of a “thermal energy” generating device or component. For example, the “temperature” of two components is the same when the two components are in “thermal” equilibrium.

In this description, the terms “workload,” “process load,” “process workload” and “block of code” are used interchangeably and generally directed toward the processing burden, or percentage of processing burden, that is associated with, or may be assigned to, a given processing component in a given embodiment. Further to that which is defined above, a “processing component” or “thermal energy generating component” or “thermal aggressor” may be, but is not limited to, a central processing unit, a graphical processing unit, a core, a main core, a sub-core, a processing area, a hardware engine, etc. or any component residing within, or external to, an integrated circuit within a portable computing device.

In this description, the term “portable computing device” (“PCD”) is used to describe any device operating on a limited capacity power supply voltage and clock generator frequency, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

Calibration margin optimization of components(s) in a PCD that includes various thermal aggressors located around its chip may be accomplished by leveraging the diverse performance characteristics of the thermal aggressors to manage the operating temperature(s) of nearby component(s) that require calibration. As would be understood by one of ordinary skill in the art, a given thermal aggressor in the form of a processing core will exhibit a certain power leakage rate at a given workload capacity and power supply and, therefore, generate a certain amount of thermal energy that conducts through nearby components.

Advantageously, embodiments of a calibration margin optimization (“CMO”) solution identify thermal aggressors strategically located on the chip and cause those thermal aggressors to vary their thermal energy generation such that the operating temperature of nearby components may be managed during a calibration procedure. It is envisioned that the thermal energy generation levels of a given thermal aggressor may be managed by a CMO solution through workload scheduling and/or voltage scaling. As would be understood by one of ordinary skill in the art, a dynamic control and voltage scaling (“DCVS”) algorithm may be leveraged to adjust the power frequency supplied to a processing component so that thermal energy generation is affected. Moreover, it is envisioned that a software application may be leveraged to simulate a desired workload level in order to affect thermal energy generation.

As a non-limiting example, consider an over the air (“OTA”) upgrade of a double data rate (“DDR”) memory component to a higher maximum frequency. As would be understood by one of ordinary skill in the art, for optimum performance of the upgraded DDR a calibration should be performed at a target operating temperature (most probably, “room temperature” as determined by the manufacturer of the PCD and/or DDR). Recognizing that the target operating temperature is higher than the active operating temperature, and also recognizing that the calibration should ideally be conducted with the DDR at the target operating temperature, a CMO embodiment may cause nearby thermal aggressors to increase thermal energy generation. Causing a nearby thermal aggressor to increase thermal energy generation may be accomplished by a CMO embodiment any number of ways including, but not limited to, increasing the power supply to the thermal aggressor, increasing a workload scheduled to the thermal aggressor, applying a simulated workload to the thermal aggressor, etc. Notably, the increase in thermal energy generation by the thermal aggressors may effectively raise the operating temperature of the DDR to the target operating temperature, thereby ensuring that the upgraded DDR is optimally calibrated.

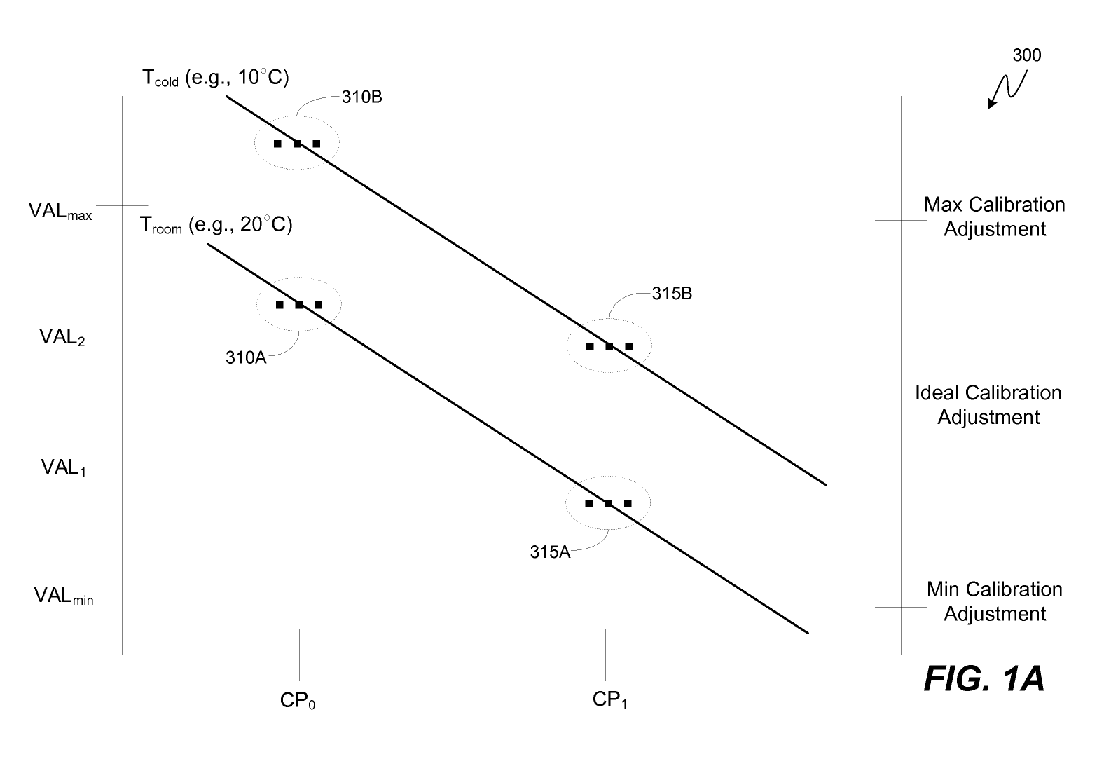

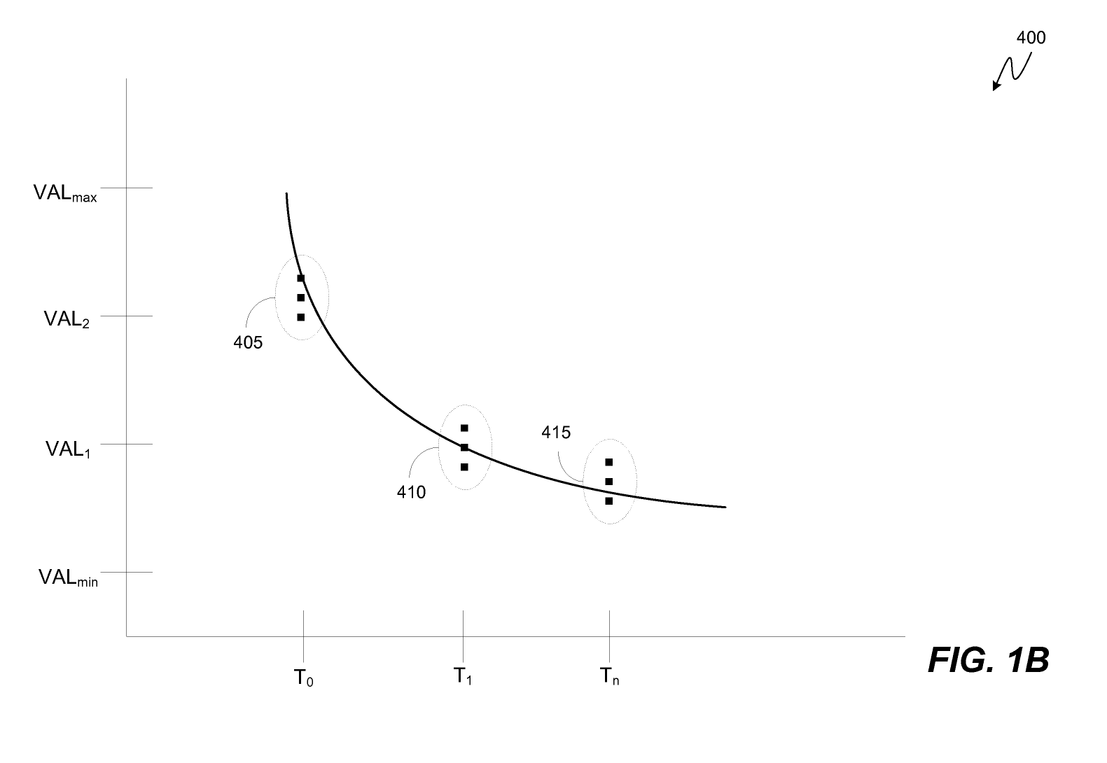

FIG. 1A is a graph 300 illustrating a pair of calibration curves of an exemplary component operating under different thermal conditions. The left-side vertical axis of the graph represents a range of measurement values for a given parameter associated with the calibration of the exemplary component. The right-side vertical axis of the graph represents a range of available calibration adjustment relative to the measurement values. And, the horizontal axis represents a series of control points at which the measurement values are taken during a calibration procedure.

As an example, consider the exemplary graph 300 within the context of a DDR memory component undergoing a calibration after an upgrade of its maximum frequency capability. The control points along the horizontal axis may be associated with read/write transaction traffic and the measurement values may be associated with latency levels. In the example, the right-side vertical axis may represent the range of adjustment available for transaction processing speed.

As can be seen from the graph 300, the calibration curve associated with the component is ideally positioned relative to the left-side and right-side vertical axes when the operating temperature of the component is at or near the ideal temperature for calibration, i.e., at or near room temperature (in the example, Tᵣₒₒₘ=20° C.). At calibration points CP₀ and CP₁, the sampled values 310A and 315A hover around VAL₂ and VAL₁, respectively, on the left-side vertical axis. As such, the ideal calibration adjustment on the right-side vertical axis corresponds roughly to the center of curve associated with the operating temperature at Tᵣₒₒₘ.

By contrast, the calibration curve associated with the component is skewed upward relative to the left-side and right-side vertical axes when the operating temperature of the component is relatively cooler than the ideal temperature for calibration (in the example, T_{cold}=10° C.). At calibration points CP₀ and CP₁, the sampled values 310B and 315B hover above VALₘₐₓ and around VAL₂, respectively, on the left-side vertical axis. As such, the ideal calibration adjustment on the right-side vertical axis corresponds to the lower end of the curve associated with the operating temperature at T_{cold}.

Consequently, and as one of ordinary skill in the art would recognize, calibration of the exemplary component associated with the curves in the graph 300 would be best conducted when the component has an operating temperature at, or near, the Tᵣₒₒₘ. When the component is at or near room temperature, the calibration adjustment range is optimized. As such, CMO solutions may recognize that the active operating temperature of a component is cooler than the ideal operating temperature and leverage thermal energy generation capabilities of nearby thermal aggressors to raise the operating temperature of the component prior to performing a calibration procedure.

FIG. 1B is a graph 400 illustrating an exemplary calibration curve for an exemplary component that requires multiple calibration points at varying operating temperatures such as, for example, an analog component or an RF (i.e., radio frequency) component. As can be seen in the graph 400, the exemplary component requires data points be taken at multiple operating temperatures in order for a calibration procedure to be optimally conducted. Such calibration procedures may be difficult, if not impossible, to implement when the PCD is in control of a third party other than the party implementing the calibration. As such, CMO solutions may leverage thermal energy generation capabilities of nearby thermal aggressors to systematically raise the operating temperature of the component during a calibration procedure.

Referring to the graph 400, for example, an exemplary CMO solution may cause nearby thermal aggressors, such as processing cores, to generate thermal energy that conducts through the component associated with calibration graph 400. Consequently, the operating temperature of the component may rise from T₀ to T₁ to Tₙ such that calibration data points 405, 410, 415, respectively, may be sampled at each target operating temperature. Using the values of the samples at the various target operating temperatures, a given calibration algorithm may be effectively executed as would be understood by one of ordinary skill in the art. Notably, without the ability to systematically elevate the operating temperature of the component to be calibrated, and control the temperature delta between each operating point, a calibration algorithm requiring the component to run at multiple operating temperatures may not be performed outside the control of the PCD manufacturer.

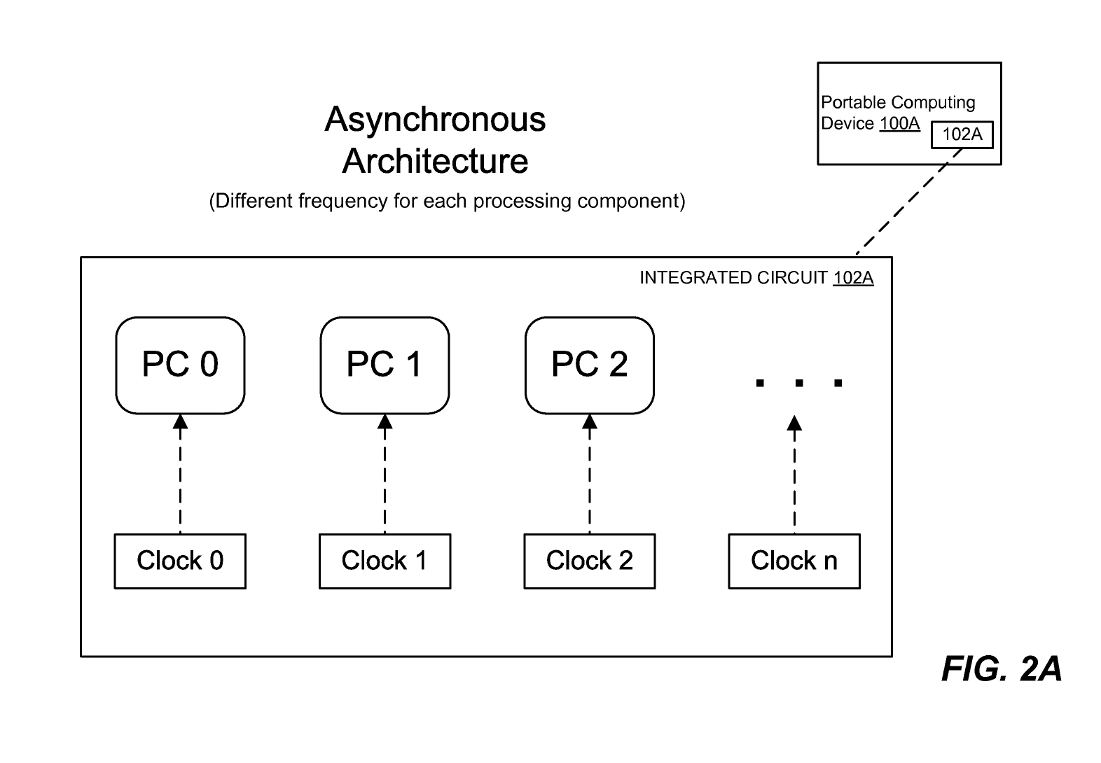

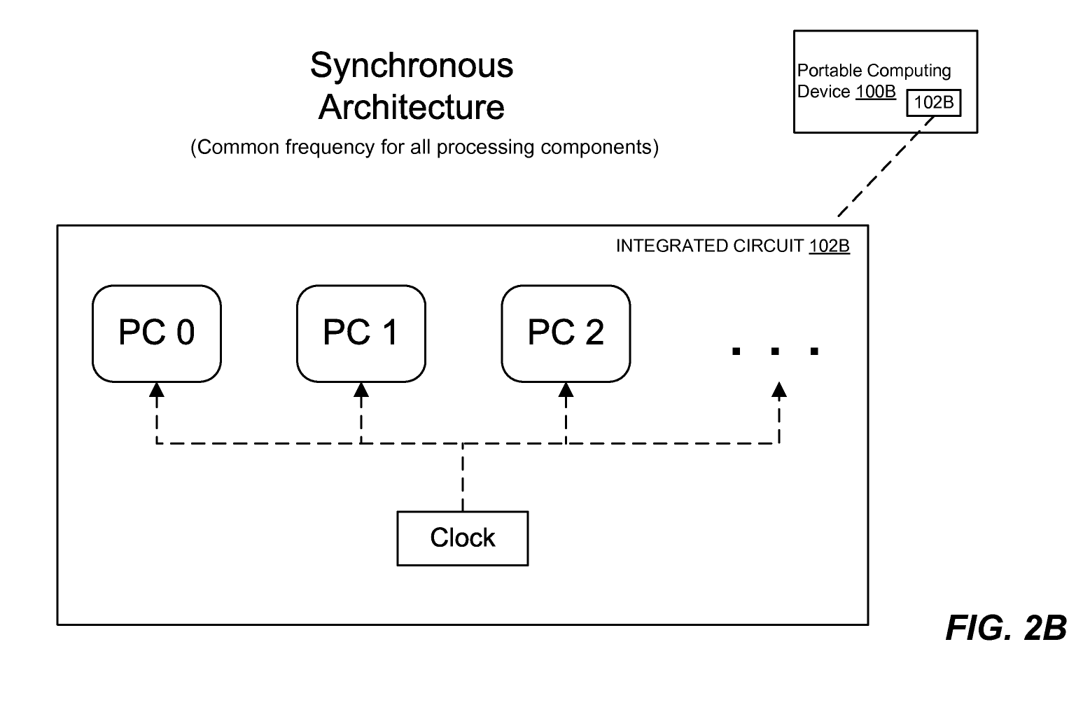

FIG. 2A is a functional block diagram illustrating aspects of an asynchronous architecture in an on-chip system 102A that includes multiple processing components that may be used by a calibration margin optimization (“CMO”) solution to manage the operating temperature of a nearby component during a calibration process. Certain embodiments of a CMO solution may be applied within the context of a SoC having an asynchronous architecture.

The on-chip system 102A is depicted to show a series of processing components PC 0, PC 1, PC 2, etc. The processing components are thermal aggressors that may be leveraged by a CMO solution to generate thermal energy that effectively elevates the operating temperature of other components nearby on the chip 102A (not shown in the FIG. 2A illustration). Notably, because the architecture of on-chip system 102A is asynchronous, each of the processing components is associated with a dedicated clock source for controlling power supply voltage and clock generator frequency, such as a phase locked loop (“PLL”) as would be understood by one of ordinary skill in the art. In the illustration, Clock 0 is uniquely associated with the power supply and clock generator to PC 0. Clock 1 is uniquely associated with the power supply and clock generator to PC 1. Clock 2 is uniquely associated with the power supply and clock generator to PC 2, and so on.

Advantageously, because each processing component in an asynchronous on-chip system has a dedicated clock source, embodiments of a CMO solution may use a DCVS module to make targeted power adjustments in an effort to generate thermal energy that affects the operating temperature of a nearby component undergoing a calibration.

FIG. 2B is a functional block diagram illustrating aspects of a synchronous architecture in an on-chip system 102B that includes multiple processing components that may be used by a calibration margin optimization (“CMO”) solution to manage the operating temperature of a nearby component during a calibration process. Certain embodiments of a CMO solution may be applied within the context of a SoC having a synchronous architecture.

The on-chip system 102B is depicted to show a series of processing components PC 0, PC 1, PC 2, etc. The processing components are thermal aggressors that may be leveraged by a CMO solution to generate thermal energy that effectively elevates the operating temperature of other components nearby on the chip 102B (not shown in the FIG. 2B illustration). Notably, because the architecture of on-chip system 102B is synchronous, each of the processing components is associated with a single, common clock source and power supply to all the processing components. Advantageously, because each processing component in a synchronous on-chip system shares a single clock source, embodiments of a CMO solution allocate and/or reallocate workloads to certain processing components in an effort to generate thermal energy that affects the operating temperature of a nearby component undergoing a calibration.

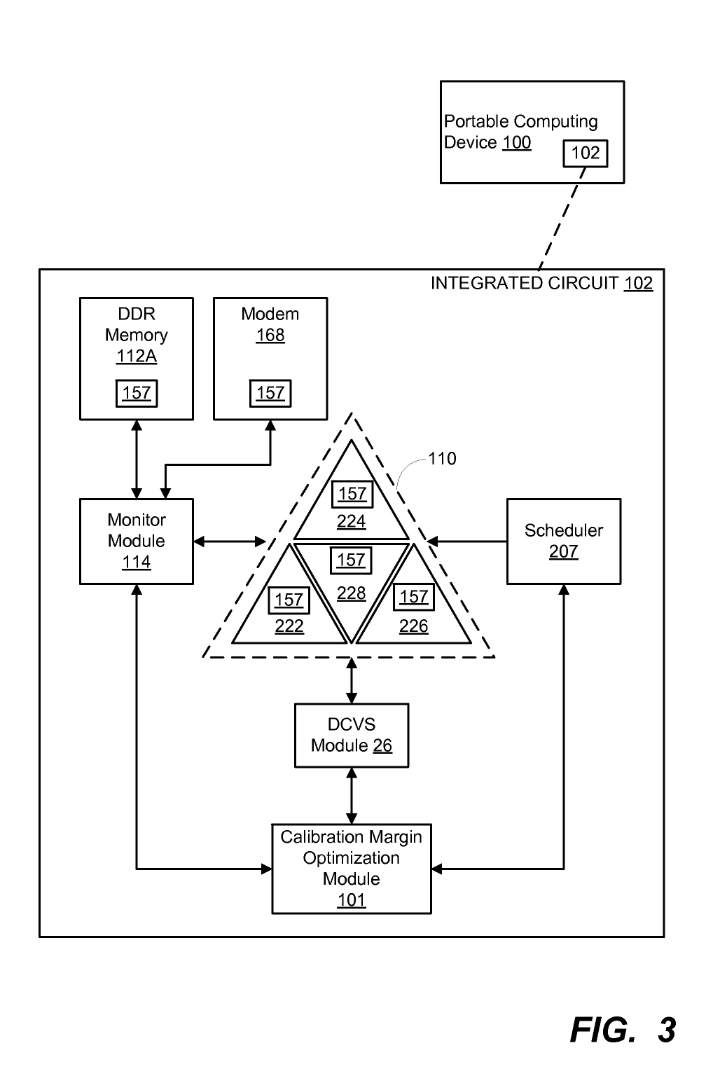

FIG. 3 is a functional block diagram illustrating an embodiment of an on-chip system 102 for calibration margin optimization (“CMO”) in a portable computing device (“PCD”) 100. Notably, it is envisioned that the on-chip system 102 may be synchronous or asynchronous in architecture. As explained above, the targeted adjustment in power supply voltage and clock generator frequency and/or workload allocation across thermally aggressive components on the chip 102, such as individual cores or processors 222, 224, 226, 228, may be used to elevate the operating temperatures of nearby components in need of a calibration (such as DDR 112A or Modem 168). Notably, although the exemplary CMO solution is being described within the context of thermal aggressors that are cores, it is envisioned that the thermal aggressors leveraged by a CMO solution may be any processing component including, but not limited to, a CPU, GPU, DSP, programmable array, video encoder/decoder, system bus, camera sub-system (image processor), MDP, etc.

Returning to the FIG. 3 illustration, the exemplary thermal aggressor(s) 110 is depicted as a group of heterogeneous processing engines for illustrative purposes only and may represent a single processing component having multiple, heterogeneous cores 222, 224, 226, 228 or multiple, heterogeneous processors 222, 224, 226, 228, each of which may or may not comprise multiple cores and/or sub-cores. As such, the reference to processing engines 222, 224, 226 and 228 herein as “cores” will be understood as exemplary in nature and will not limit the scope of the disclosure.

The on-chip system 102 may monitor temperature sensors 157, which may be individually associated with both thermally aggressive cores 222, 224, 226, 228 and components identified for calibration (e.g., DDR 112A and Modem 168), with a monitor module 114. The monitor module 114 may be in communication with a calibration margin optimization (“CMO”) module 101 that is in communication with a DCVS module 26 and a scheduler module 207. Notably, although in the FIG. 3 illustration the monitor module 114 is depicted to monitor temperatures associated with thermal aggressors and specific, exemplary components needing calibration, it is envisioned that a monitor module 114 may also monitor any number of thermal energy indicators such as, but not limited to, a skin temperature sensor, a PoP memory temperature sensor, a junction temperature sensor, a current sensor on power rails to processing components, a current sensor associated with a power supply, a power supply capacity sensor, etc. Moreover, although the exemplary components identified for calibration in the FIG. 3 illustration are depicted on the chip 102, it is envisioned that certain CMO embodiments may execute on the chip 102 for the purpose of calibrating the interface or interoperation between the chip 102 and components that reside off-chip such as, for example, a DDR memory component or an analog component within an RF integrated circuit.

In the event that a component requires calibration, the monitor module may determine the operating temperature of the component and provide the reading to the CMO module 101. If the CMO module 101 determines that the current operating temperature of the component (such as DDR 112A or modem 168) is below an ideal operating temperature for calibration, the CMO module 101 may select one or more thermal aggressors (such as cores 222, 224, 226, 228) suitably positioned on the chip 102 for elevating the operating temperature of the target component needing calibration.

In an asynchronous architecture, the CMO module 101 may determine to increase the power supply voltage and clock generator frequency to one or more thermal aggressors, thereby increasing their respective thermal energy generation. Or, in a synchronous architecture, the CMO module 101 may cause workloads to be allocated or reallocated from one thermal aggressor to another, or queued workloads to be scheduled to strategic thermal aggressors. Notably, it is also envisioned that a CMO solution may leverage both adjustments in voltage/frequency and workload allocations regardless of the particular chip architecture. The dynamic DCVS adjustment policies dictated by the CMO module 101 may set processor clock speeds at increased levels on certain thermal aggressor(s) physically located on the chip 102 in a place that serves to affect the operating temperature of nearby components identified for calibration. In some embodiments, workload allocations and/or reallocations dictated by the CMO module 101 may be implemented via instructions to the scheduler 207. Notably, through application of CMO thermal management policies, the CMO module 101 may leverage thermal energy generation of one component to manage the operating temperature of a nearby component undergoing a calibration. As such, it will be understood that a CMO module 101, in its effort to optimize the operating temperature of a component identified for calibration, may elevate or decrease the thermal energy generation level of a thermal aggressor near the identified component.

As one of ordinary skill in the art will recognize, the thermal energy generation of one or more of the processing cores 222, 224, 226, 228 may fluctuate as workloads are processed, ambient conditions change, adjacent thermal energy generators dissipate energy, etc. As the thermal energy generation levels associated with each of the cores 222, 224, 226, 228 change, the monitor module 114 recognizes the change and may transmit temperature data indicating the change to the CMO module 101. Similarly, the monitor module 101 may recognize changes in the operating temperature of the identified component for calibration and transmit updated temperature readings of the component to the CMO module 101. The change in measured operating temperatures may trigger the CMO module 101 to adjust the power frequency supplied to a thermal aggressor (via DCVS module 26), modify the workloads assigned to a thermal aggressor (via scheduler 207), conclude the calibration procedure, etc.

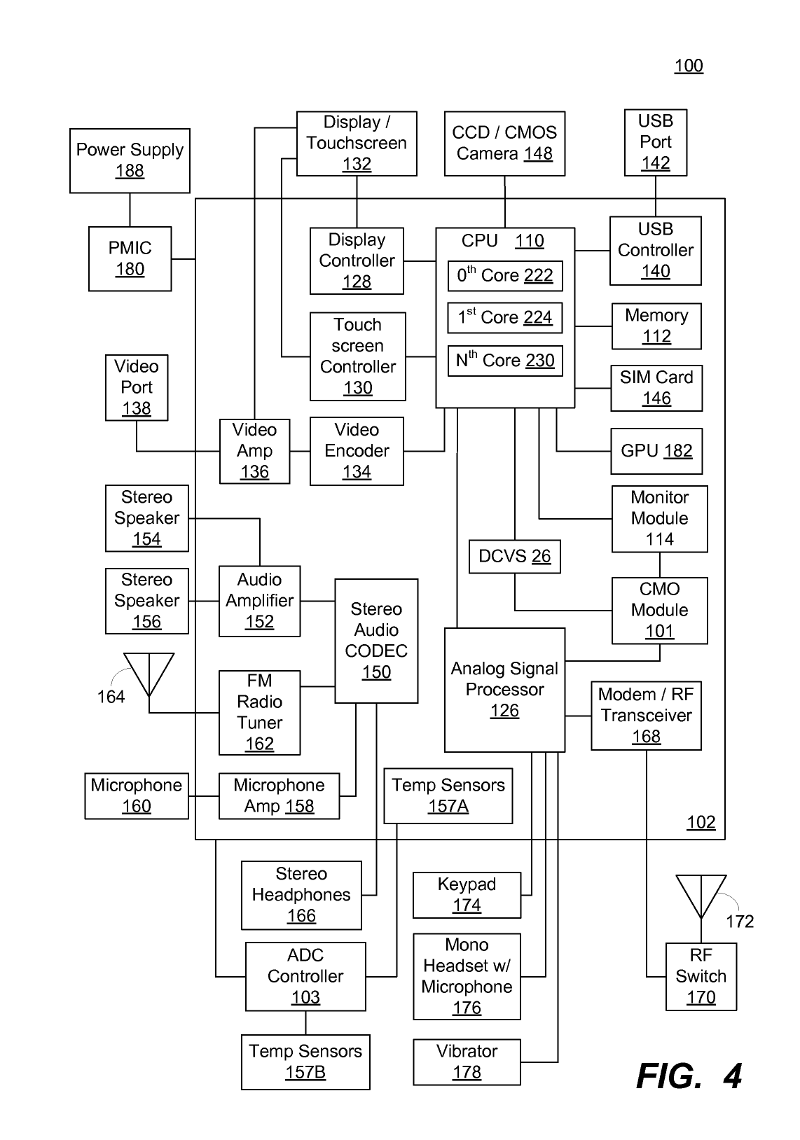

FIG. 4 is a functional block diagram of an exemplary, non-limiting aspect of a PCD 100 in the form of a wireless telephone for implementing methods and systems for calibration margin optimization (“CMO”) of component(s) within the PCD 100 that are undergoing a calibration process. As shown, the PCD 100 includes an on-chip system 102 that includes a heterogeneous multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the CMO module(s) 101 may receive temperature data from the monitor module 114 and use the temperature data to selectively increase or decrease thermal energy generated by the cores 222, 224, 230 via a DCVS module 26 and/or scheduler 207. The increased or decreased thermal energy generation may be dictated by the operating temperature of a component on the chip 102 that is targeted for calibration and monitored by the monitor module 114. The monitor module 114 communicates with multiple operational sensors (e.g., thermal sensors 157) distributed throughout the on-chip system 102 and with the CPU 110 of the PCD 100 as well as with the CMO module(s)101.

As illustrated in FIG. 4, a display controller 128 and a touchscreen controller 130 are coupled to the digital signal processor 110. A touchscreen display 132 external to the on-chip system 102 is coupled to the display controller 128 and the touchscreen controller 130.

PCD 100 may further include a video decoder 134, e.g., a phase-alternating line (“PAL”) decoder, a sequential couleur avec memoire (“SECAM”) decoder, a national television system(s) committee (“NTSC”) decoder or any other type of video decoderl34. The video decoder 134 is coupled to the multi-core central processing unit (“CPU”) 110. A video amplifier 136 is coupled to the video decoder 134 and the touchscreen display 132. A video port 138 is coupled to the video amplifier 136. As depicted in FIG. 4, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 4, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 4, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 4 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 4 further indicates that a modem or radio frequency (“RF”) transceiver 168 may be coupled to the analog signal processor 126. An RF switch 170 may be coupled to the RF transceiver 168 and an RF antenna 172. As shown in FIG. 4, a keypad 174 may be coupled to the analog signal processor 126. Also, a mono headset with a microphone 176 may be coupled to the analog signal processor 126. Further, a vibrator device 178 may be coupled to the analog signal processor 126. FIG. 4 also shows that a power supply 188, for example a battery, is coupled to the on-chip system 102 via a power management integrated circuit (“PMIC”) 180. In a particular aspect, the power supply 188 includes a rechargeable DC battery or a DC power supply that is derived from an alternating current (“AC”) to DC transformer that is connected to an AC power source. Notably, it is envisioned that in some embodiments the power supply 188 and/or PMIC 180 may be leveraged by a CMO module 101 as a thermal aggressor to generate thermal energy that works to elevate the operating temperature of a component in the PCD 100 undergoing calibration.

The CPU 110 may also be coupled to one or more internal, on-chip thermal sensors 157A as well as one or more external, off-chip thermal sensors 157B via the monitor module 114. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller 103. However, other types of thermal sensors 157 may be employed without departing from the scope of the invention.

The thermal sensors 157, in addition to being controlled and monitored by an ADC controller 103, may also be controlled and monitored by one or more CMO module(s) 101. The CMO module(s) 101 may comprise software that is executed by the CPU 110. However, the CMO module(s) 101 may also be formed from hardware and/or firmware without departing from the scope of the invention. The CMO module(s) 101 may be responsible for querying processor performance data and/or receiving indications of processor performance and, based on an analysis of the data, adjusting the power frequencies and/or allocating or reallocating blocks of code to processors best positioned to affect the operating temperature of a component in need of calibration.

Returning to FIG. 4, the touchscreen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, and the power supply 180/188 are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in the memory 112 that form the one or more CMO module(s) 101. The instructions that form the CMO module(s) 101 may be executed by the CPU 110, the analog signal processor 126, or another processor in addition to the ADC controller 103 to perform the methods described herein. Further, the processors 110, 126, the memory 112, the instructions stored therein, or a combination thereof may serve as a means for performing one or more of the method steps described herein.

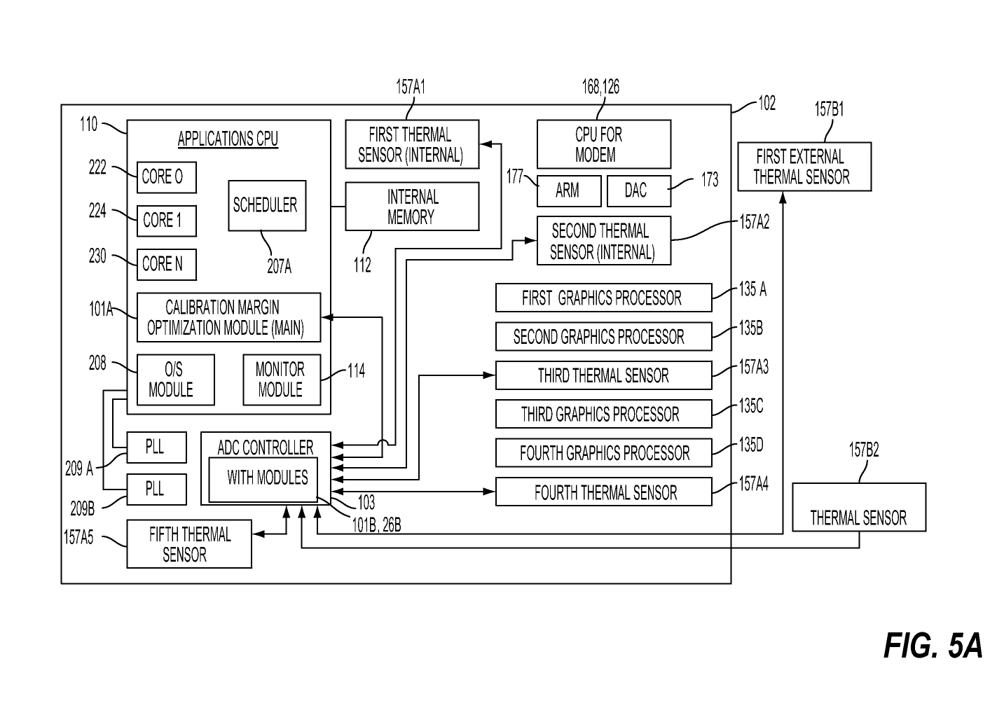

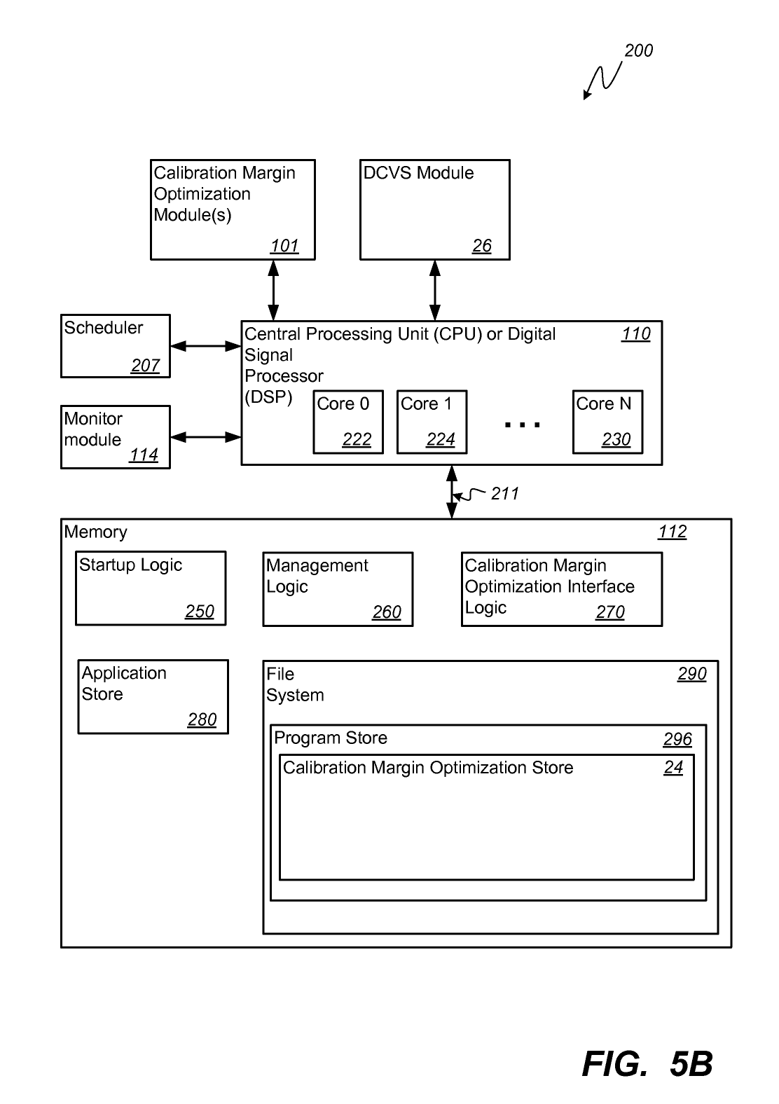

FIG. 5A is a functional block diagram illustrating an exemplary spatial arrangement of hardware for the chip 102 illustrated in FIG. 4. According to this exemplary embodiment, the applications CPU 110 is positioned on the far left side region of the chip 102 while the modem CPU 168, 126 is positioned on a far right side region of the chip 102. The applications CPU 110 may comprise a heterogeneous multi-core processor that includes a zeroth core 222, a first core 224, and an Nth core 230. The applications CPU 110 may be executing an CMO module 101A (when embodied in software) or it may include CMO module 101A (when embodied in hardware). The application CPU 110 is further illustrated to include operating system (“O/S”) module 208 and a monitor module 114.

The applications CPU 110 may be coupled to one or more phase locked loops (“PLLs”) 209A, 209B, which are positioned adjacent to the applications CPU 110 and in the left side region of the chip 102. Adjacent to the PLLs 209A, 209B and below the applications CPU 110 may comprise an analog-to-digital (“ADC”) controller 103 that may include its own CMO module 101B that works in conjunction with the main module 101A of the applications CPU 110.

The CMO module 101B of the ADC controller 103 may be responsible, in conjunction with the monitor module 114, for monitoring and tracking multiple thermal sensors 157 that may be provided “on-chip” 102 and “off-chip” 102. The on-chip or internal thermal sensors 157A may be positioned at various locations and associated with various components.

As a non-limiting example, a first internal thermal sensor 157A1 may be positioned in a top center region of the chip 102 between the applications CPU 110 and the modem CPU 168,126 and adjacent to internal memory 112. A second internal thermal sensor 157A2 may be positioned below the modem CPU 168, 126 on a right side region of the chip 102. This second internal thermal sensor 157A2 may also be positioned between an advanced reduced instruction set computer (“RISC”) instruction set machine (“ARM”) 177 and a first graphics processor 135A. A digital-to-analog controller (“DAC”) 173 may be positioned between the second internal thermal sensor 157A2 and the modem CPU 168, 126.

A third internal thermal sensor 157A3 may be positioned between a second graphics processor 135B and a third graphics processor 135C in a far right region of the chip 102. A fourth internal thermal sensor 157A4 may be positioned in a far right region of the chip 102 and beneath a fourth graphics processor 135D. And a fifth internal thermal sensor 157A5 may be positioned in a far left region of the chip 102 and adjacent to the PLLs 209 and ADC controller 103.

One or more external thermal sensors 157B may also be coupled to the ADC controller 103. The first external thermal sensor 157B1 may be positioned off-chip and adjacent to a top right quadrant of the chip 102 that may include the modem CPU 168, 126, the ARM 177, and DAC 173. A second external thermal sensor 157B2 may be positioned off-chip and adjacent to a lower right quadrant of the chip 102 that may include the third and fourth graphics processors 135C, 135D.

One of ordinary skill in the art will recognize that various other spatial arrangements of the hardware illustrated in FIG. 5A may be provided without departing from the scope of the invention. FIG. 5A illustrates one exemplary spatial arrangement and how the main CMO module 101A and ADC controller 103 with its CMO module 101B may work with a monitor module 114 to recognize thermal conditions that are a function of the exemplary spatial arrangement illustrated in FIG. 5A and leverage those conditions to optimize a calibration of one or more components.

FIG. 5B is a schematic diagram illustrating an exemplary software architecture of the PCD 100 of FIG. 4 and FIG. 5A for supporting application of calibration margin optimization (“CMO”) algorithms. Any number of algorithms may form or be part of at least one calibration margin optimization technique that may be applied by the CMO module 101 when a component is identified for calibration.

As illustrated in FIG. 5B, the CPU or digital signal processor 110 is coupled to the memory 112 via a bus 211. The CPU 110, as noted above, may be a multiple-core, heterogeneous processor having N core processors. That is, the CPU 110 may include a first core 222, a second core 224, and an N^{th} core 230. As is known to one of ordinary skill in the art, each of the first core 222, the second core 224 and the N^{th} core 230 are available for supporting a dedicated application or program and, as part of a heterogeneous processor, may provide differing levels of performance under similar operating conditions. Alternatively, one or more applications or programs can be distributed for processing across two or more of the available heterogeneous cores.

The CPU 110 may receive commands from the CMO module(s) 101 that may comprise software and/or hardware. If embodied as software, the CMO module 101 comprises instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 5B, it should be noted that one or more of startup logic 250, management logic 260, calibration margin optimization interface logic 270, applications in application store 280 and portions of the file system 290 may be stored on any computer-readable medium for use by or in connection with any computer-related system or method.

In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the calibration margin optimization interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor (or additional processor cores).

The startup logic 250 includes one or more executable instructions for selectively identifying, loading, and executing a select program for calibration margin optimization of a component in need of calibration. The management logic 260 includes one or more executable instructions for terminating CMO program, as well as selectively identifying, loading, and executing a more suitable replacement program for calibration margin optimization. The management logic 260 is arranged to perform these functions at run time or while the PCD 100 is powered and in use by an operator of the device. A replacement program can be found in the program store 296 of the embedded file system 290.

The replacement program, when executed by one or more of the core processors in the digital signal processor, may operate in accordance with one or more signals provided by the CMO module 101 and monitor module 114. In this regard, the monitor module 114 may provide one or more indicators of events, processes, applications, resource status conditions, elapsed time, temperature, etc in response to control signals originating from the CMO module 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the management logic 260 that instructs the PCD 100 to adjust voltage supply to a certain level for a certain thermal aggressor when an operating temperature measurement associated with a component in need of calibration is below room temperature. By way of further example, the inputs may include a change to the management logic 260 that instructs the PCD 100 to reduce power by one increment to a certain thermal aggressor when the operating temperature of a component in need of calibration is 5 degrees above a target temperature.

The interface logic 270 enables a manufacturer to controllably configure and adjust a CMO policy under defined operating conditions on the PCD 100. When the memory 112 is a flash memory, one or more of the startup logic 250, the management logic 260, the interface logic 270, the application programs in the application store 280 or information in the embedded file system 290 can be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged calibration margin optimization store 24. In this regard, the file system 290 may include a reserved section of its total file system capacity for the storage of information associated with the particular CMO policies applicable for particular components during a calibration.

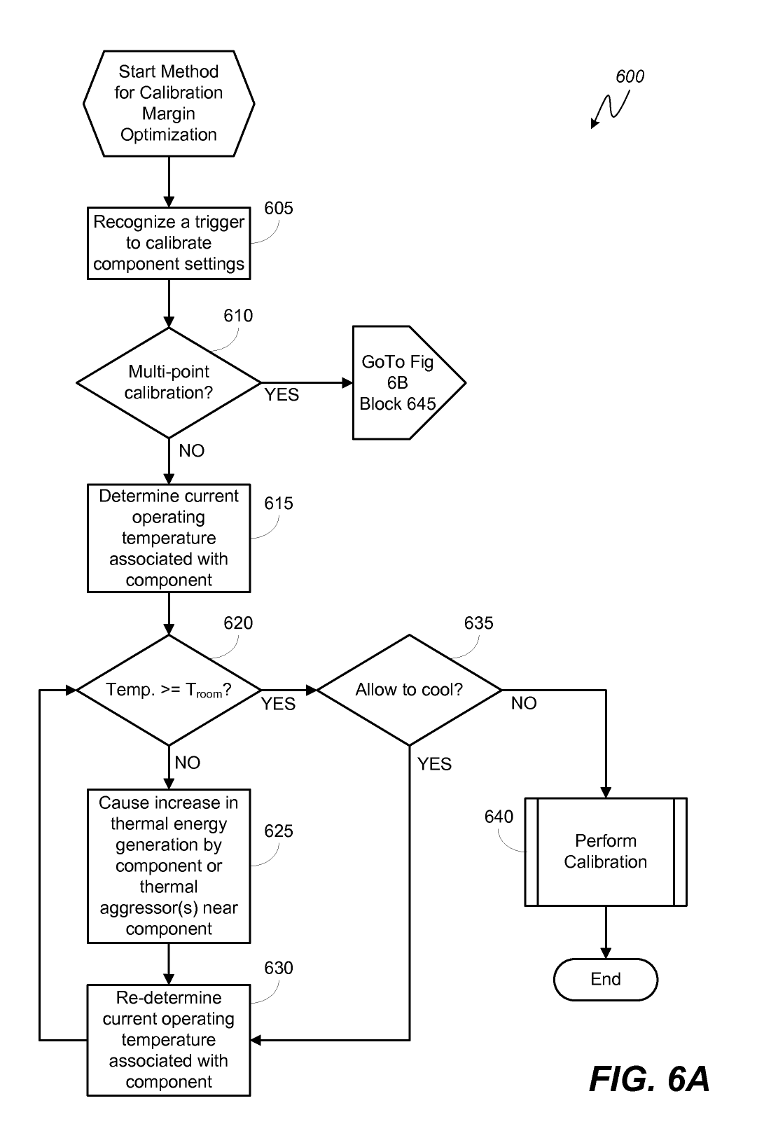

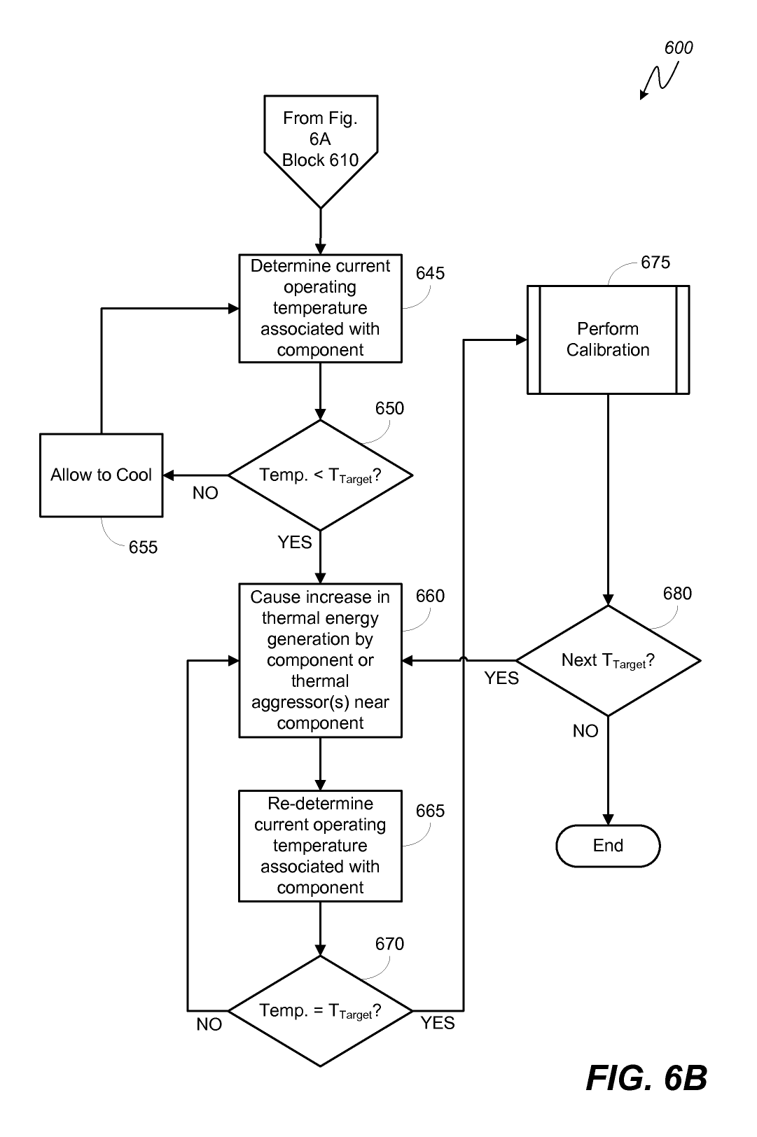

FIGS. 6A-6B depict a logical flowchart illustrating an embodiment of a method 600 for calibration margin optimization (“CMO”) of a component in a system on a chip (“SoC”) 102. Beginning at block 605, the CMO module 101 may recognize a trigger or need for a certain component or components to be calibrated. The calibration may be needed in conjunction with an upgrade to the component, for example. At decision block 610, the CMO module 101 may determine whether the calibration algorithm requires multiple data points to be taken at multiple control points, such as at multiple operating temperatures. Notably, some calibration algorithms may only require that the calibration be performed with the component at a steady operating temperature (such as room temperature) while other calibration algorithms may require the operating temperature to be adjusted to various levels during the calibration. If the calibration is a single point calibration (such as that illustrated and described in relation to the FIG. 1A graph), i.e. the operating temperature should be held at or near a target operating temperature with minimal variance, the method 600 follows the “no” branch to block 615.

At block 615, the monitor module may determine the current, active operating temperature of the identified component in need of calibration. Next, at decision block 620, if the active operating temperature is cooler than the optimal operating temperature for performing the calibration, the “no” branch is followed to block 625 and the CMO module 101 may cause an increase in the thermal energy generation level of a nearby thermal aggressor. As described above, it is envisioned that the CMO module 101 may cause an increase in thermal energy generation by a thermal aggressor via modification of DCVS settings and/or allocation of workloads. Advantageously, the increase in thermal energy generation by the thermal aggressors may be leveraged by the CMO module 101 to elevate the operating temperature of the component to be calibrated to an optimal operating temperature, such as Tᵣₒₒₘ.

After the thermal energy generation of one or more thermal aggressors has been changed, at block 630 the monitor module 114 may re-determine the operating temperature of the targeted component to verify that the operating temperature has been positively affected by the conduction of thermal energy dissipating from the thermal aggressors. The method loops back to decision block 620 and the re-determined or updated operating temperature reading of the targeted component is compared to the optimal operating temperature for the calibration, i.e. it may be compared to Tᵣₒₒₘ. The method may continue to loop through blocks 620, 625 and 630 until the operating temperature of the target component is elevated to the optimal operating temperature for the calibration.

If at anytime the decision block 620 determines that the current, active operating temperature of the target component is higher than the optimal temperature, the method moves to decision block 635 and a decision is made as to whether the target component should be allowed to cool before calibration. If the election is made to allow the target component to cool, then the method loops down to block 630 and the operating temperature is periodically sampled until the actual operating temperature is within an acceptable deviation from the optimal operating temperature, at which point the “yes” branch would be followed from decision block 620 and the “no” branch subsequently followed from decision block 635. The method 600 proceeds from the “no” branch of 635 when the actual, current operating temperature of the target component is within an acceptable deviation from the optimal operating temperature for the calibration. Following the “no” branch from decision block 635, at block 640 the calibration of the target component may be implemented. Advantageously, because the calibration at block 640 is conducted while the operating temperature of the target component is at or near the optimal operating temperature, i.e. at or near Tᵣₒₒₘ, the calibration will be optimized. The method 600 ends.

Returning to decision block 610, if the CMO module 101 determines that the calibration algorithm requires the target component to be at varying operating temperatures throughout the calibration procedure, the “yes” branch is followed to block 645 of FIG. 6B. At block 645, the current, active operating temperature of the target component is determined by the monitor module 114. At decision block 650, if the current operating temperature of the target component is above the range of operating temperatures required for calibration, the method 600 may follow the “no” branch to block 655 where the target component is allowed to cool prior to implementation of the calibration procedure. The method 600 may loop through blocks 645, 650 and 655 with the monitor module 114 periodically sampling the operating temperature of the target component until it is adequately cooled.

If at decision block 650 it is determined that the current operating temperature is below the first target temperature for the calibration process, the method follows the “yes” branch to block 660. At block 660, the CMO module 101 may cause nearby thermal aggressors to increase thermal energy generation such that the operating temperature of the target component is elevated to the first target temperature. Once the monitor module 114 determines at block 665 and decision block 670 that the operating temperature is within an acceptable deviation from the target temperature, the calibration is performed at block 675. Subsequently, at decision block 680 the CMO technique may determine that the calibration process requires the operating temperature of the target component to be raised to another, higher operating temperature. If so, the “yes” branch is followed to block 660 and the method 600 continues as previously described until the calibration process at block 675 is completed for each operating temperature point. Once all operating temperature points have been achieved, the “no” branch is followed from decision block 680 and the method 600 ends. The target component has been optimally calibrated.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for calibration margin optimization of a target component in a portable computing device, the method comprising:
determining that a target component requires calibration;
determining that a current operating temperature of the target component is cooler than an optimal operating temperature for the calibration;
increasing thermal energy generation by one or more thermally aggressive components near the target component, wherein the increased thermal energy generation works to adjust the current operating temperature of the target component;
determining that the adjusted current operating temperature of the target component is within an acceptable deviation from the optimal operating temperature; and
performing the calibration of the target component at the adjusted current operating temperature.

2. The method of claim 1, wherein increasing the thermal energy generation by one or more thermally aggressive components comprises modifying a power supply voltage.

3. The method of claim 1, wherein increasing the thermal energy generation by one or more thermally aggressive components comprises modifying a clock generator frequency.

4. The method of claim 1, wherein increasing the thermal energy generation by one or more thermally aggressive components comprises modifying a workload allocation.

5. The method of claim 1, wherein the calibration requires one or more increases to the operating temperature of the target component and the optimal operating temperature is one of a plurality of optimal operating temperatures, further comprising:
further increasing thermal energy generation by one or more thermally aggressive components near the target component, wherein the further increased thermal energy generation works to adjust the adjusted current operating temperature of the target component to a second adjusted current operating temperature;
determining that the second adjusted current operating temperature of the target component is within an acceptable deviation from a second optimal operating temperature; and
performing the calibration of the target component at the second adjusted current operating temperature.

6. The method of claim 1, wherein the system on a chip comprises one of an asynchronous architecture and a synchronous architecture.

7. The method of claim 1, wherein the calibration of the target component is associated with an interoperation of the target component and a chip and wherein the target component resides off-chip or within a hardware block integrated in the chip.

8. The method of claim 1, wherein the portable computing device is in the form of a wireless telephone.

9. A computer system for calibration margin optimization of a target component in a portable computing device, the system comprising:
a calibration margin optimization module comprising a processor and a memory device, the module configured to:
determine that a target component requires calibration;
determine that a current operating temperature of the target component is cooler than an optimal operating temperature for the calibration;
increase thermal energy generation by one or more thermally aggressive components near the target component, wherein the increased thermal energy generation works to adjust the current operating temperature of the target component;
determine that the adjusted current operating temperature of the target component is within an acceptable deviation from the optimal operating temperature; and
perform the calibration of the target component at the adjusted current operating temperature.

10. The computer system of claim 9, wherein the calibration margin optimization module increasing the thermal energy generation by one or more thermally aggressive components comprises modifying a power supply voltage.

11. The computer system of claim 9, wherein the calibration margin optimization module increasing the thermal energy generation by one or more thermally aggressive components comprises modifying a clock generator frequency.

12. The computer system of claim 9, wherein the calibration margin optimization module increasing the thermal energy generation by one or more thermally aggressive components comprises modifying a workload allocation.

13. The computer system of claim 9, wherein the calibration requires one or more increases to the operating temperature of the target component and the optimal operating temperature is one of a plurality of optimal operating temperatures, the calibration margin optimization module further configured to:
further increase thermal energy generation by one or more thermally aggressive components near the target component, wherein the further increased thermal energy generation works to adjust the adjusted current operating temperature of the target component to a second adjusted current operating temperature;
determine that the second adjusted current operating temperature of the target component is within an acceptable deviation from a second optimal operating temperature; and
perform the calibration of the target component at the second adjusted current operating temperature.

14. The computer system of claim 9, wherein the system on a chip comprises one of an asynchronous architecture and a synchronous architecture.

15. The computer system of claim 9, wherein the calibration of the target component is associated with an interoperation of the target component and a chip and wherein the target component resides off-chip or within a hardware block integrated in the chip.

16. The computer system of claim 9, wherein the portable computing device is in the form of a wireless telephone.

17. A computer system for calibration margin optimization of a target component in a portable computing device, the system comprising:
means for determining that a target component requires calibration;
means for determining that a current operating temperature of the target component is cooler than an optimal operating temperature for the calibration;
means for increasing thermal energy generation by one or more thermally aggressive components near the target component, wherein the increased thermal energy generation works to adjust the current operating temperature of the target component;
means for determining that the adjusted current operating temperature of the target component is within an acceptable deviation from the optimal operating temperature; and
means for performing the calibration of the target component at the adjusted current operating temperature.

18. The computer system of claim 17, wherein means for increasing the thermal energy generation by one or more thermally aggressive components comprises means for modifying a power supply voltage.

19. The computer system of claim 17, wherein means for increasing the thermal energy generation by one or more thermally aggressive components comprises means for modifying a clock generator frequency.

20. The computer system of claim 17, wherein means for increasing the thermal energy generation by one or more thermally aggressive components comprises means for modifying a workload allocation.

21. The computer system of claim 17, wherein the calibration requires one or more increases to the operating temperature of the target component and the optimal operating temperature is one of a plurality of optimal operating temperatures, further comprising:
means for further increasing thermal energy generation by one or more thermally aggressive components near the target component, wherein the further increased thermal energy generation works to adjust the adjusted current operating temperature of the target component to a second adjusted current operating temperature;
means for determining that the second adjusted current operating temperature of the target component is within an acceptable deviation from a second optimal operating temperature; and
means for performing the calibration of the target component at the second adjusted current operating temperature.

22. The computer system of claim 17, wherein the system on a chip comprises one of an asynchronous architecture and a synchronous architecture.

23. The computer system of claim 17, wherein the calibration of the target component is associated with an interoperation of the target component and a chip and wherein the target component resides off-chip or within a hardware block integrated in the chip.

24. A computer program product comprising a non-transitory computer usable device having a computer readable program code embodied therein, said computer readable program code adapted to be executed to implement a method for calibration margin optimization of a target component in a portable computing device, said method comprising:
determining that a target component requires calibration;
determining that a current operating temperature of the target component is cooler than an optimal operating temperature for the calibration;
increasing thermal energy generation by one or more thermally aggressive components near the target component, wherein the increased thermal energy generation works to adjust the current operating temperature of the target component;
determining that the adjusted current operating temperature of the target component is within an acceptable deviation from the optimal operating temperature; and
performing the calibration of the target component at the adjusted current operating temperature.

25. The computer program product of claim 24, wherein increasing the thermal energy generation by one or more thermally aggressive components comprises modifying a power supply voltage.

26. The computer program product of claim 24, wherein increasing the thermal energy generation by one or more thermally aggressive components comprises modifying a clock generator frequency.

27. The computer program product of claim 24, wherein increasing the thermal energy generation by one or more thermally aggressive components comprises modifying a workload allocation.

28. The computer program product of claim 24, wherein the calibration requires one or more increases to the operating temperature of the target component and the optimal operating temperature is one of a plurality of optimal operating temperatures, further comprising:
further increasing thermal energy generation by one or more thermally aggressive components near the target component, wherein the further increased thermal energy generation works to adjust the adjusted current operating temperature of the target component to a second adjusted current operating temperature;
determining that the second adjusted current operating temperature of the target component is within an acceptable deviation from a second optimal operating temperature; and
performing the calibration of the target component at the second adjusted current operating temperature.

29. The computer program product of claim 24, wherein the system on a chip comprises one of an asynchronous architecture and a synchronous architecture.

30. The computer program product of claim 24, wherein the calibration of the target component is associated with an interoperation of the target component and a chip and wherein the target component resides off-chip or within a hardware block integrated in the chip.
